(19) United States
(12) Patent Application Publication
(10) Pub. No.: US 2016/0167646 A1
(43) Pub. Date: Jun. 16, 2016

(54) AUTOMATED PREPARATION METHODS AND SYSTEMS

(71) Applicant: GM GLOBAL TECHNOLOGY OPERATIONS LLC, Detroit, MI (US)

(72) Inventors: J. WILLIAM HANDZEL, JR., BEVERLY HILLS, MI (US); JOSHUA R. AUDEN, BRIGHTON, MI (US)

(21) Appl. No.: 14/568,358

(22) Filed: Dec. 12, 2014

(51) Int. Cl. B60W 30/00

(52) U.S. Cl. CPC B60W 30/00

(57) ABSTRACT

Methods and systems automatically controlling a vehicle are provided. In one embodiment, a method includes: determining that a vehicle operating mode has been selected by a user; and in response to the determining, automatically preparing at least one component of the vehicle for the vehicle operating mode.

### TECHNICAL FIELD

The technical field generally relates to automated systems of a vehicle, and more particularly relates to methods and systems for automatically preparing vehicle systems.

### BACKGROUND

Some road vehicles are designed to provide high performance features. For example, a road vehicle may include the option of selecting a certain high performance mode (e.g., via a button, a switch, or other user input). Once selected by the user, the vehicle enters the performance mode whereby the vehicle is capable of operating at a certain capability. However, in some cases, components of the vehicle are not able to immediately perform at that capability. For example, high performance brake components (e.g., high-friction capability brake pads) need to be operating at a certain temperature (e.g., at or above 100 degrees Celsius) to provide maximum performance capability. In certain instances, the brake components may not be operating at such temperatures when the high performance mode is selected by a user.

Accordingly, it is desirable to provide methods and systems for automatically preparing a vehicle for a performance mode. Furthermore, other desirable features and characteristics of the present invention will become apparent from the subsequent detailed description and the appended claims, taken in conjunction with the accompanying drawings and the foregoing technical field and background.

### SUMMARY

Methods and systems for automatically controlling a vehicle are provided. In one embodiment, a method includes: determining that a vehicle operating mode has been selected by a user; and in response to the determining, automatically preparing at least one component of the vehicle for the vehicle operating mode.

In one embodiment, a system includes a first module that determines that a vehicle operating mode has been selected by a user. A second module, in response to the determination, automatically prepares at least one component of the vehicle for the vehicle operating mode. In another embodiment, the component may include a brake pad.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a mode preparation system in accordance with various embodiments;

FIG. 2 is a dataflow diagram illustrating a control module of the mode preparation system in accordance with various embodiments; and

FIG. 3 is a flowchart illustrating a control method of the mode preparation system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of control systems, and that the vehicle system described herein is merely one example embodiment of the invention.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

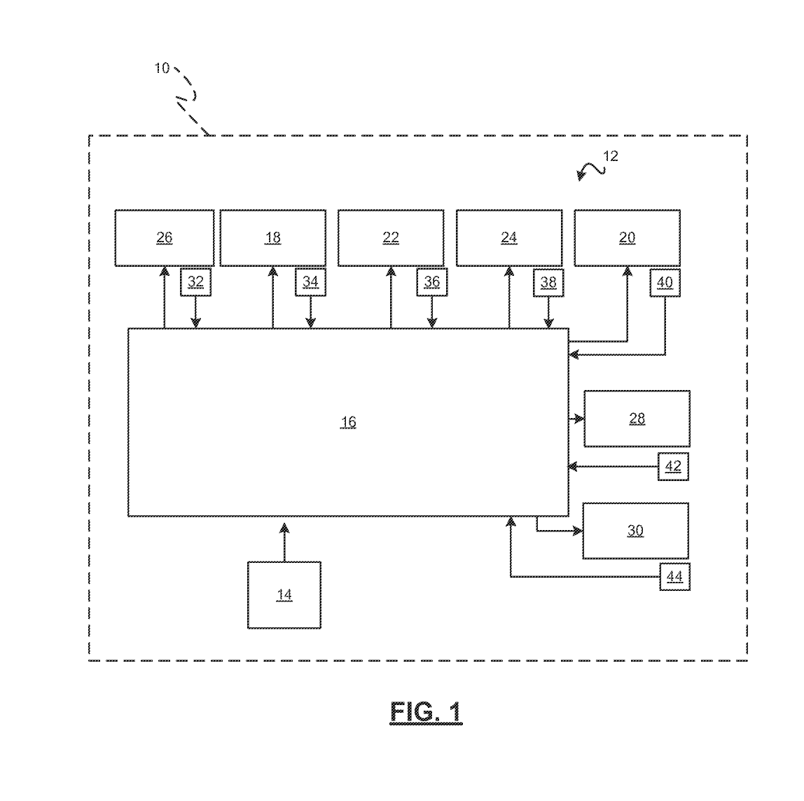

Referring now to FIG. 1, a vehicle 10 is shown to include a vehicle operation mode preparation system 12 in accordance with various embodiments. For exemplary purposes, the disclosure will be discussed in the context of the mode preparation system 12 being a system that automatically prepares the vehicle for high performance type operation modes (e.g., operation modes where one or more of he components perform at or near an optimum performance capability). As can be appreciated, various embodiments of the present disclosure can include a vehicle operation mode preparation system 12 that prepares the vehicle for any type of operation mode and is not limited to the present examples. Although the figures shown herein depict an example with certain arrangements of elements, additional intervening elements, devices, features, or components may be present in an actual embodiments. It should also be understood that FIG. 1 is merely illustrative and may not be drawn to scale.

As shown, the mode preparation system 12 includes a user input device 14 that is communicatively coupled to at least one control module 16. The user input device 14 may be any device capable of interpreting a user's action. In various embodiments, the user input device 14 may be a switch, a depressible button, a selectable item on a graphical user interface, a recording device, or any other type of input device.

In various embodiments, the user's action indicates a selection of a desired mode of operation. The user input device 14 interprets the user's action and communicates a signal to the control module 16. The control module 16 receives the signal, and determines the desired mode of operation. Based on the desired mode of operation, the control module 16 generates control signals and/or communicates messages to control one or more components of the vehicle 10. The control module 16 controls the one or more components such that the component or a component associated with the controlled component is prepared for the desired mode of operation. In one example, the control module 16 controls the one or more components such that the component or the associated component is capable of operating at a capability associated with the mode. In the case of the performance mode, the capability is an optimal capability.

As can be appreciated, the components to be prepared can be any component of the vehicle 10. Given the high performance mode example, the components to be prepared include, but are not limited to, a brake component such as brake pads or other components of a brake system 18, a pump component such as a fuel pump of a fuel system 20, an intercooler pump of s supercharger system 22, a differential pump of a differential system 24, a line pressure pump of a transmission system 26, or other type of fluid pump, a tire component of tire system 28, and/or an aerodynamic component of an aerodynamic system 30. The control module 16 prepares the components by generating a control signal to control the component or another component associated with the component and/or by communicating messages (e.g., via a communication bus) to other control modules (not shown) that control the component or another component associated with the component.

In various embodiments, the control module 16 communicates with one or more sensors 32-44. The sensors 32-44 sense observable conditions of the various components and generate signals based thereon. In various embodiments, at least one of the sensors 32-44 is a temperature sensor. For example, the sensor 32-44 senses a temperature of the component or a temperature of a fluid associated with the component. In various embodiments, at least one of the sensors 32-44 is a pressure sensor. For example, the sensor 32-44 senses a pressure of fluid associated with the component. As can be appreciated, the sensors 32-44 may include other sensors and are not limited to the present examples. In various embodiments, the control module 16 receives the sensor signals and determines whether the component is prepared for the desired mode of operation. If it is determined that the component is not prepared for the desired mode of operation, the control module 16 generates the control signals and/or communicates the messages such that the component is prepared.

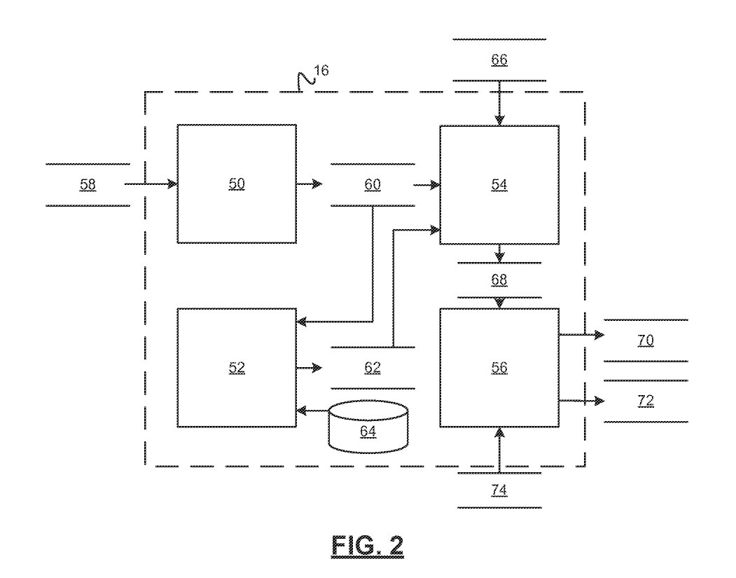

Referring now to FIG. 2 and with continued reference to FIG. 1, a dataflow diagram illustrates various embodiments of the control module 16 of the mode preparation system 12. Various embodiments of the control module 16 according to the present disclosure may include any number of sub-modules. As can be appreciated, the sub-modules shown in FIG. 2 may be combined and/or further partitioned to similarly prepare the vehicle 10 for the desired operating mode. Inputs to the control module 16 may be received from the user input device 14, received from the sensors 32-44, received from other control modules (not shown) of the vehicle 10, and/or determined by other sub-modules (not shown) of the control module 16. In various embodiments, the control module 16 includes a mode determination module 50, a component determination module 52, a component evaluation module 54, and a component control module 56.

The mode determination module 50 receives as input a user input signal 58. The user input signal 58 may be generated based on a user's interaction with the user input device 14. The mode determination module 50 determines a desired mode 60 based on the user input signal 58. The desired mode 60 can be, for example, a performance mode, a default mode, or other type of mode.

The component determination module 52 receives as input the desired mode 60. Based on the desired mode 60, the component determination module 52 determines which components may require preparation. In various embodiments, a list of components 62 may be associated with a particular mode and the list and association may be stored in a datastore 64. The component determination module 52 determines the components for the desired mode 60 based on the stored list and association. For example, as discussed above the list of components associated with a performance mode may include, but is not limited to, brake components, pump components, tire components, and aerodynamic components.

The component evaluation module 54 receives as input the desired mode 60 and the list of components 62. The component evaluation module 54 further receives as input current values 66 of conditions associated with the components of the list of components 62. The current values 66 may be sensed values (e.g., received from the sensors 32-44) or modeled/estimated values. For example, the current values 66 may indicate a temperature or a pressure of the component or a fluid associated with the component.

The component evaluation module 54 evaluates the current values 66 to determine if the current values 66 meet a desired value. The component evaluation module 54 determines the desired value for each component based on the desired mode 60. For example, if the desired mode is the performance mode, the desired value may be an optimal operating value associated with the component.

If the current value 66 fails to meet the desired value, the component evaluation module 54 determines a control value 68 for controlling the component or a component associated with the component such that the desired value may be achieved. For example, if the desired mode 60 is the performance mode, the current component is a brake component, and the desired value is an optimal temperature, the component evaluation module 54 determines a force to be applied by the brake pads to achieve the optimal temperature. In another example, if the desired mode 60 is the performance mode, the current component is a pump component, and the desired value is an optimal pressure, the component evaluation module determines an optimal fluid amount to be provided to the pump to achieve the optimal pressure. In still another example, if the current mode is the performance mode, the current component is a tire component, and the desired value is an optimal temperature, the component evaluation module determines an optimal tire angle to control the tires to such that the optimal temperature may be achieved.

The component control module 56 receives as input the determined control values 68. In various embodiments, the component control module 56 generates control signals 70 to directly control the component or a component associated with the component based on the determined control value 68. In various other embodiments, the component control module 56 generates messages 72 (that are received by other control modules that control the component) to indirectly control the component or a component associated with the component based on the determined control value 68.

For example, the component control module 56 generates control signals 70 or messages 72 to control a temperature of a component (e.g., such as the brake pads, or the tires). The control signals 70 or the messages 72 are generated until the desired temperature is achieved. The component control module 56 determines that the desired temperature is achieved based on a received current value 74. The current values 74 may be sensed values (e.g., received from the sensors 32-44) or modeled/estimated values. In another example, the component control module 56 generates control signals 70 or messages 72 to control a pressure of a component (e.g., a pump component). The control signals 70 or the messages 72 are generated until a desired pressure is achieved. The component control module 56 determines that the desired pressure is achieved based on a received current value 74. The current values 74 may be sensed values (e.g., received from the sensors 32-44) or modeled/estimated values.

In various embodiments, the component control module 56 generates control signals 70 or messages 72 when driving conditions are such that the component or the component associated with the component can be controlled and can be controlled without impairing the overall function of the component during the driving condition. For example, the component control module 56 evaluates driving conditions before generating the control signals 70 or messages 72.

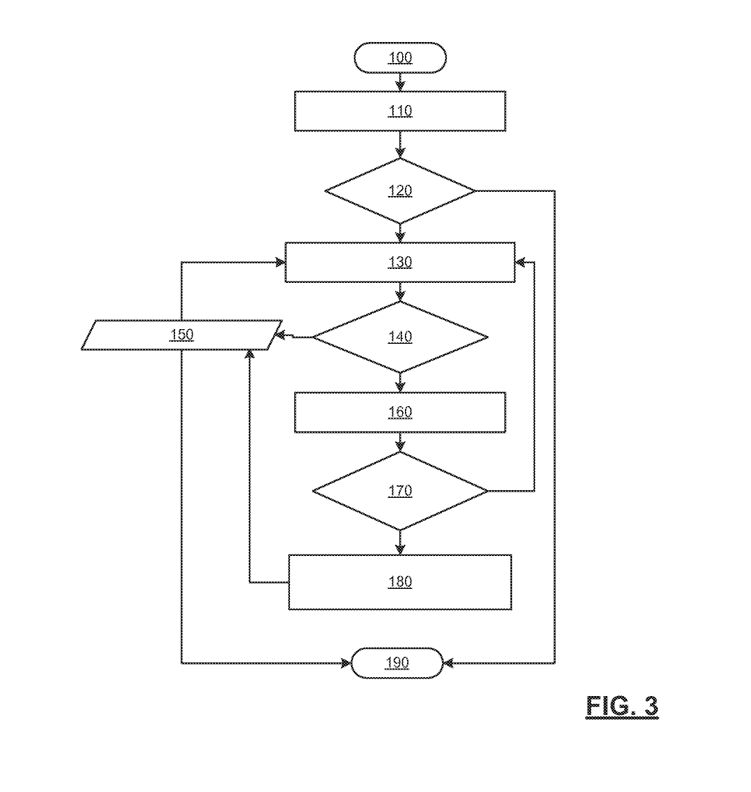

Referring now to FIG. 3, and with continued reference to FIGS. 1 and 2, a flowchart illustrates a control method that can be performed by the mode preparation system 12 of FIGS. 1 and 2 in accordance with various embodiments. As can be appreciated in light of the disclosure, the order of operation within the method is not limited to the sequential execution as illustrated in FIG. 3, but may be performed in one or more varying orders as applicable and in accordance with the present disclosure.

As can further be appreciated, the method of FIG. 3 may be scheduled to run at predetermined time intervals during operation of the vehicle 10 and/or may be scheduled to run based on predetermined events.

In one example, the method may begin at 100. The user input signal 58 is received and processed to determine the desired mode 60 at 110. It is determined whether a performance mode (or other mode in other embodiments) is selected at 120. If the performance mode is not selected at 120, it is assumed a default mode is selected and the method may end at 190. If, however, a performance mode is selected at 120, the current value X of a component Y is determined/received at 130. For example, if the component is a brake pad, the temperature A of the brake pad is sensed or modeled.

The current value X of the component Y is evaluated to determine if it has met the optimal value (or other value depending on the desired mode) for the component Y. For example, if the component is the brake pad, the current temperature A (sensed or modeled) of the brake pad is evaluated to see if it is at or above the optimal temperature (e.g., 100 degrees Celsius).

If the current value X of the component Y meets the optimal value at 140, the method continues with selecting the next component from the component list 62 that requires evaluation for the performance mode at 150. If, however, the current value X of the component Y does not meet the optimal value at 140, the control value Z to achieve the optimal value is determined at 160. For example, given the brake pad example, a required force C to achieve the optimal temperature B is determined, for example, given the current temperature A. The current driving conditions are evaluated at 170 to determine if automated control can be performed. For example, given the brake pad example, if the transmission range is a drive range, then the conditions are met.

If the conditions are not met at 170, the method continues with determining the current value X of the component Y at 130 and comparing the current value X to the optimal value Y at 140. If, however, the driving conditions are met at 170, the control signals 70 and/or messages 72 are generated at 180 based on the determined control value Z. For example, given the brake pad example, the control signal 72 is generated to apply the brake pads at the required force C such that the optimal temperature can be achieved. Thereafter, the method continues with selecting the next component from the list of components 62 that requires evaluation for the performance mode at 150. If all of the components associated with the performance mode have been evaluated at 150, the method may end at 190.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A automated method of controlling a vehicle, comprising:
determining that a vehicle operating mode has been selected by a user; and
in response to the determining, automatically preparing at least one component of the vehicle for the vehicle operating mode.

2. The method of claim 1, wherein the vehicle operating mode is a high performance operating mode.

3. The method of claim 1, wherein the automatically preparing comprises automatically preparing a temperature of the component.

4. The method of claim 3, wherein the component is a brake component.

5. The method of claim 3, wherein the component is a tire component.

6. The method of claim 1, wherein the automatically preparing comprises generating a control signal to control the component or another component associated with the component such that a desired temperature of the component is achieved.

7. The method of claim 1, wherein the automatically preparing comprises communicating a message to a control module to control the component or another component associated with the component such that a desired temperature of the component is achieved.

8. The method of claim 1, wherein the automatically preparing comprises automatically preparing pressure of fluid associated with the component.

9. The method of claim 8, wherein the component is a pump component.

10. The method of claim 8, wherein the pump component is associated with at least one of a transmission, a fuel system, a differential, and a supercharger.

11. The method of claim 1, wherein the automatically preparing comprises generating a control signal to control the component or another component associated with the component such that a desired pressure of fluid associated with the component is achieved.

12. The method of claim 1, wherein the automatically preparing comprises communicating a message to a control module to control the component or another component associated with the component such that a desired pressure of fluid associated with the component is achieved.

13. The method of claim 1, wherein the automatically preparing comprises determining a control value to achieve a desired value of the component.

14. The method of claim 13 wherein the control value is a force.

15. The method of claim 13, where in the control value is a fluid amount value.

16. The method of claim 13, wherein the control value is a tire angle value.

17. The method of claim 1, wherein the automatically preparing comprises determining if conditions have been met to automatically control the component or a component associated with the component, and selectively controlling the component or the component associated with the component in response to the determining if the conditions have been met.

18. An automated control system, comprising:
a first module that determines that a vehicle operating mode has been selected by a user; and
a second module that, in response to the determination, automatically prepares at least one component of the vehicle for the vehicle operating mode.

19. The automated control system of claim 18 further comprising a third module that determines a list of components to be prepared for the vehicle operating mode and wherein the second module automatically prepares each component of the list of components for the vehicle operating mode.

20. A vehicle, comprising:
a user input device that generates a signal based on a user's action; and
a control module that receives the signal, that determines that a vehicle operating mode has been selected based on the signal; and that, in response to the determination, automatically prepares at least one component of the vehicle for the vehicle operating mode.
